(19) United States
(12) Patent Application Publication
(10) Pub. No.: US 2018/0126917 A1
(43) Pub. Date: May 10, 2018

(54) Bike Rack

(71) Applicant: Vincent Venolia, Vista, CA (US)

(72) Inventor: Vincent Venolia, Vista, CA (US)

(21) Appl. No.: 15/802,239

(22) Filed: Nov. 2, 2017

Related U.S. Application Data
(60) Provisional application No. 62/417,796, filed on Nov. 4, 2016.

(51) Int. Cl. B60R 9/10; B60R 9/048

(52) U.S. Cl. CPC B60R 9/10; B60R 9/048

(57) ABSTRACT

This invention is directed toward a bicycle rack that fits on the back of hatchback, van or station wagon automobile. As opposed to the traditional bike rack that is large and cumbersome, and blocks the rear door/window of an automobile with a rear door window that is relatively vertical, this invention is small, lightweight, easily removable, and provides a means by which a bicycle can be quickly and securely attached to the gap between the rear door and roof of the car. The base unit has a hook section that hooks over the upper edge of a back door, and a strap section with another hook that fits over the bottom of the back door keeps the unit in place. The invention has a slot through with a bolt can secure the front fork.

### CROSS REFERENCE TO RELATED APPLICATIONS

This utility patent application claims priority to U.S. Provisional Application No. 62/417,796, also entitled “Bike Rack”, a copy of which is attached to this application and the contents of which are incorporated by reference into this application.

### STATEMENT REGARDING FEDERALLY SPONSORED RESEARCH OR DEVELOPMENT

This invention was not federally sponsored.
INVENTOR: Vincent “Vince” Venolia
Attorney Docket: Venolia-UP-1

### BACKGROUND OF THE INVENTION

Field of the invention: This invention relates to the general field of racks that store devices on an automobile, and more specifically, to a small, easily attachable/detachable bicycle rack that is designed to be mounted on the roof and the gap between the rear door/window of an SUV, hatchback, or other car/van with a relatively vertical back. While traditional bike racks either mount to the hitch receptacle or use a variety of hooks and adjustable clamps to mount across the rear door, this invention is easily and quickly attached and detached from the car.

History of the invention's industry. Ever since cars became a common part of industrial societies in the early 1900's people have been trying to figure out how to allow cars to carry objects. While in the early days, pickup trucks were the preferred (and for some objects only) means by which objects could be carried, over the years it became more and more desirable to be able to mount bicycles to cars.

At this time, there are a number of ways bicycles can be stored on cars. There are bike racks that can be attached, or are built into roof racks. There are also bike racks that can be slid into a trailer hitch receptacle and secured in an upright position. For cars with relatively vertical backs, such as SUV's, and hatchbacks, there are also bike racks that through some combination of clamps, hooks and adjustable harnesses can be secured to the back of the car.

A problem remains however, in that for the various bike racks that can be used to store bikes on the back of an SUV or hatchback—or even a van—none are easily removed, and all block access to the back of the car in one way or the other.

Thus there has existed a long-felt need for a bike rack that allows a user to store a bike on the back of a car or van with a relatively vertical back, where the bike rack is easily removable and does not block access to the rear of the car.

The current invention provides just such a solution by having a small bike rack that has a hook portion that hooks over the top of the rear door/window, and a mount portion to which a bike can be attached. The rubber seal on the inside of the door top presses against the hook portion, securing it in place, such that it does not jiggle out during driving. There is also a slot in the invention through which a nylon strap can be threaded that will be secured to the bottom of the door/window to cinch tight and hold the rack into place. The simple securing portion provides a point of attachment for the front forks and back tire of a bike. Because the invention can be secured so simply, it can be removed or installed merely by opening the back door of the car and either putting it into place or pulling it out.

### OBJECTS OF THE INVENTION

It is therefore an object of the present invention to provide a small bike rack for a car with a relatively flat back where the small bike rack can easily and efficiently mount a bicycle for transport.

It is another object of the invention to provide a bike rack that does not obscure or hinder access to the rear of the car.

Another object of the invention is to provide a bike rack that is easily installed and removed.

A further object of the invention is to provide a bike rack that securely attaches the front fork and rear tire of a bike to the back of an SUV, hatchback, van or vehicle car with a relatively flat back.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a perspective view of a bike rack on a car according to a preferred form of the invention.

FIG. 1A is a close-up view of the invention.

FIG. 2 is a perspective view of a bike rack according to a preferred form of the invention.

FIG. 3 is a front view.

FIG. 4 is a bottom view.

FIG. 5 is a top view.

FIG. 6 is a side view.

FIG. 7 is a perspective view of the invention attached with a cam strap.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

### REFERENCE NUMBERS USED

1. Bike Rack generally

2. Bike generally

3. Car roof

4. Left blank intentionally

5. Rack Base

6. Hook

7. Gap between Car Roof and Car back door

8. Upright member

9. Bike front fork

10. Rack Base Curved Edge

11. Rack Body Side Panel

12. Rack Body Front Panel

13. Rack Body Front Panel Hole

14. Rack Body Tube

15. Rack Body Tube Hole

16. Rack Body Front Hole

17. Rack Body Rear Hole

18. Hook angle

19. Bike rear wheel

20. Back wheel attachment

21. Bike sprocket

22. Left blank intentionally

23. Bottom lip of back door.

24. Attachment hook

25. Cam Strap

26. Cam Strap cinching

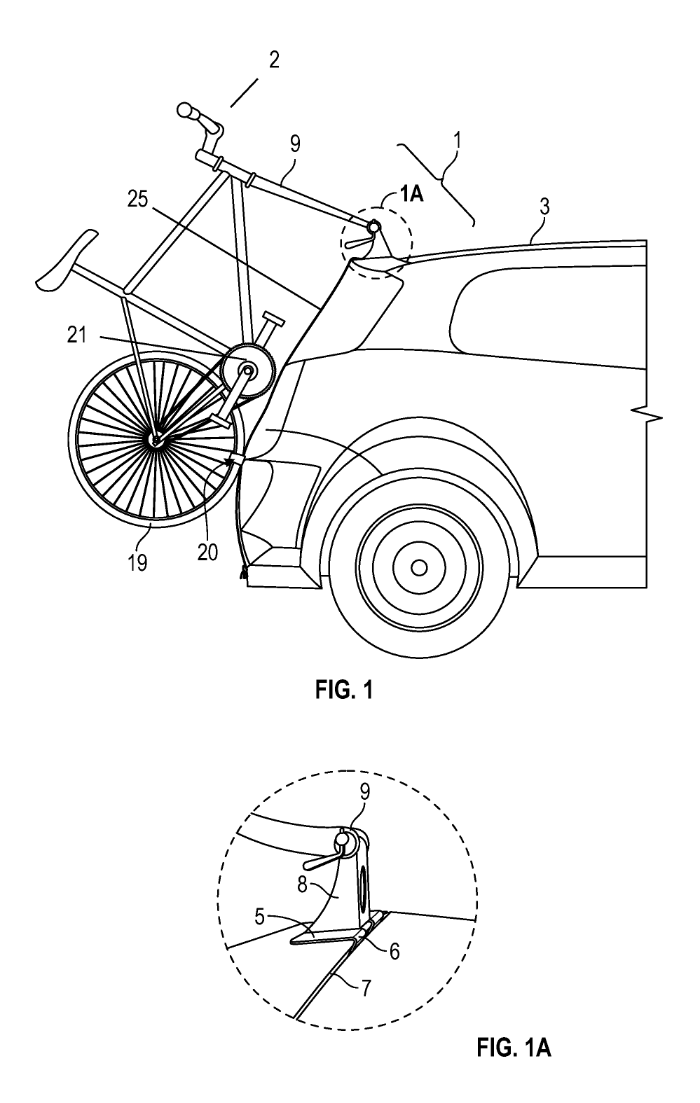

FIG. 1 is a perspective view of a bike rack on a car according to a preferred form of the invention. FIG. 1A is a close-up view of the invention. The bike rack, 1 generally, hooks in the gap 7 between the car roof 3 and the car back door 4. The bike front fork 9 attaches to the bike rack such that the bike 2 rests on the back of the car, with the bike rear wheel 19 resting on the car back bumper 20, and the bike sprocket 21 elevated safely away from the car window that is part of the car back door 4. The bike rack has a rack base 5 and rests on the car back door 4, and a hook 6 that fits into the gap 7. The bike rack has an upright member 8 that elevates the portion of the bike rack that grasps the bike front fork 9. There is also a strap (not shown in this figure) that connects the base of the invention to a hook that hooks over the bottom of the door. This strap pulls the invention against the hook 6 such that the invention is secure.

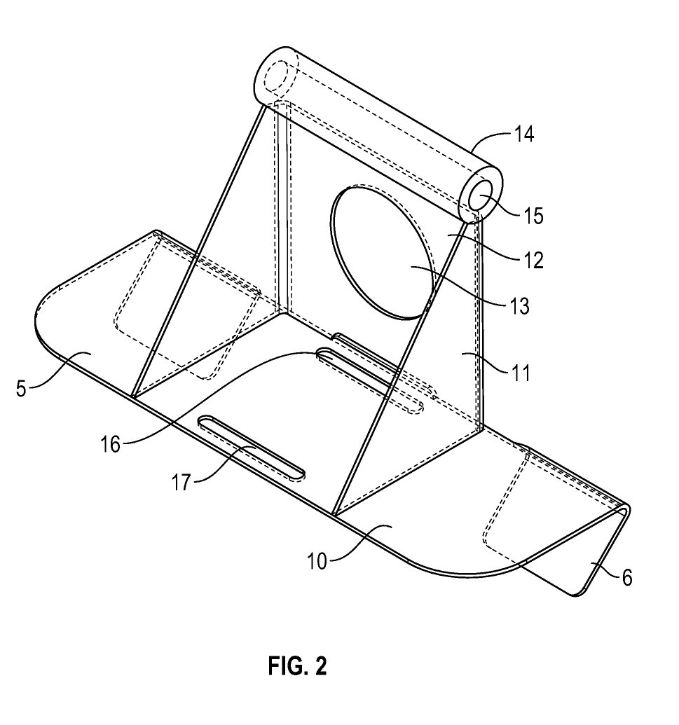

FIG. 2 is a perspective view of a bike rack according to a preferred form of the invention. The rack base 5 has curved edges 10 in this embodiment. The hook 6 extends at an angle from the rack base. The portion of the bike rack that attaches to the bike comprises a rack body tube 14 through which there is a rack body tube hole 15. The front forks of the bike are placed on either side of the rack body tube hole 15, and a bolt or front hub skewer is used to secure the front forks to the bike rack. To elevate the rack body tube 14, there is a rack body front panel 12, which in this case has a rack body front panel hole 13 to decrease the weight, and two rack body side panels 11. To use straps to cinch down the invention, there are rack body front hole 16 (this slot is optional) and rack body rear hole 17 through which straps can be inserted. The invention contemplates both single slots and double slots through which the strap can be inserted.

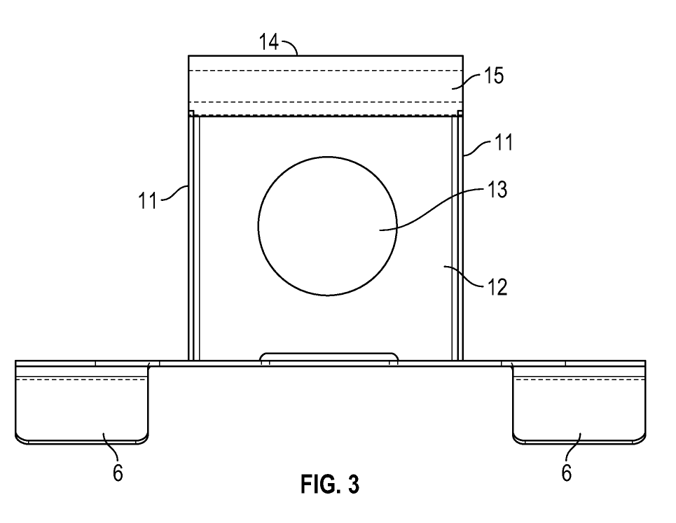

FIG. 3 is a front view. Hooks 6 hang down from the main body, ready to secure the device to the gap between the roof and back door of a car, van, or other vehicle with a relatively vertical back window. Rack body front panel hole 13 makes the unit lighter. Rack body tube 14 has a hollow cylinder in the middle, namely, rack body tube hole 15, through which a bolt can be slid to secure the front fork of a bike.

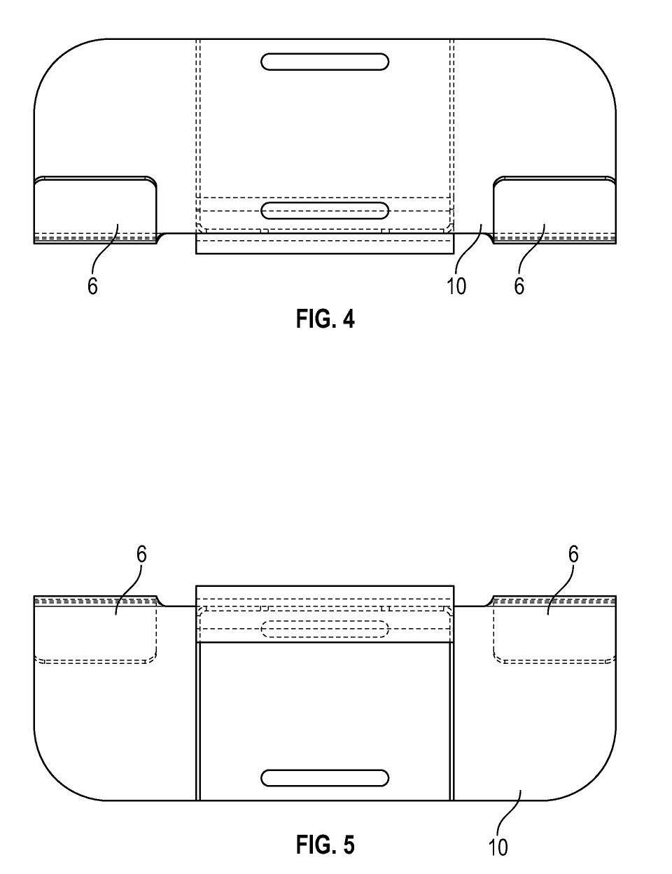

FIG. 4 is a bottom view. This figure shows two slots through which a strap can be threaded, but another version with just a single slot is contemplated.

FIG. 5 is a top view.

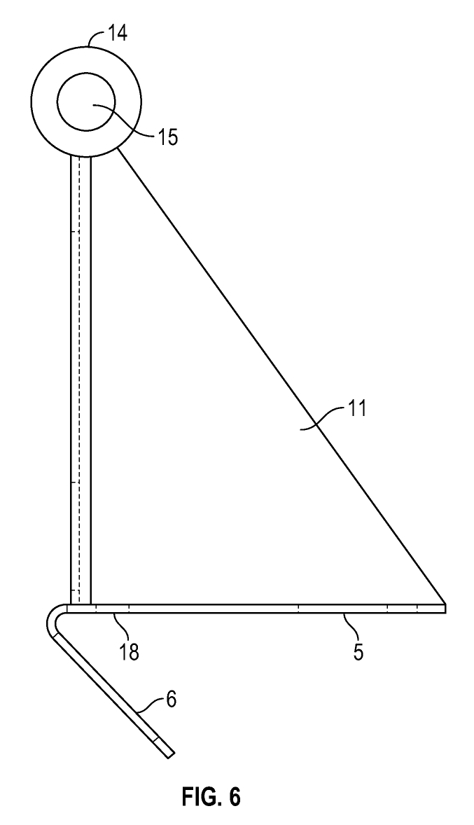

FIG. 6 is a side view. Note that hook 6 is angled back at hook angle 18 from the rack base 5. The angle 18 allows the hook 6 to rest securely in the gap. A strap then pulls “back and down” on unit to force it against the edge of the gap.

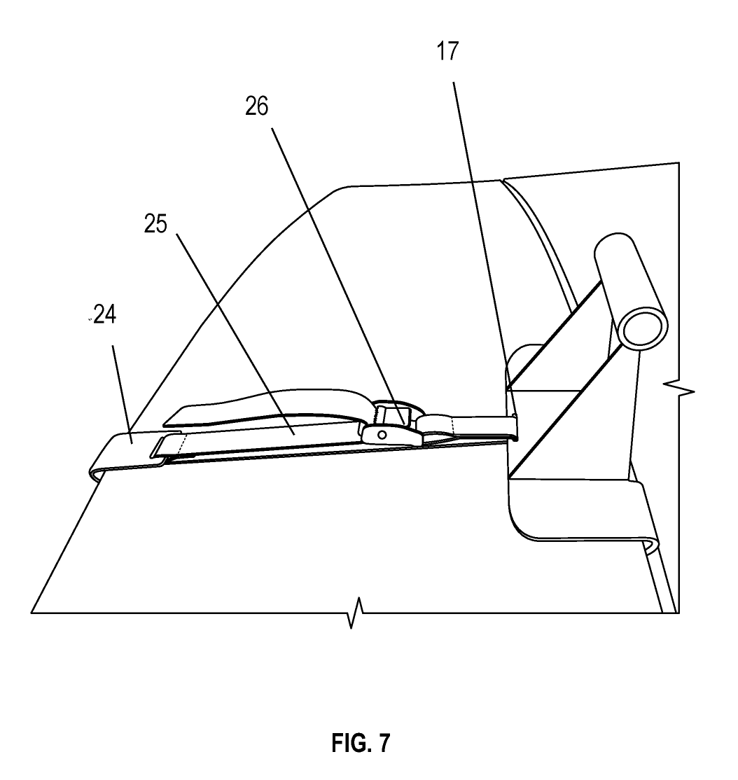

FIG. 7 is a perspective view of the invention attached with cam straps. The invention has an attachment hook 24 that fits over the bottom lip of the back door 23. A cam strap 25 has been attached through the rack body front hole 16 (as seen in FIG. 2) and the rack body rear hole 17, and the cam has been cinched 26 to secure the invention in place.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A bike rack, consisting of a rack portion and a cam strap portion,
where the rack portion comprises a rack base with at least one hook which has a hook width, where the hook width is less than an average width between a car roof and a car back door, where there is a gap between the car roof and the car back door, and where the hook is secured in the gap,
where the rack base additionally comprises one or more curved edges, a rack body hole, through which a strap can be inserted,
and the rack portion additionally comprises an upright section, where the upright section additionally comprises an upright member, where the upright member comprises two rack body side panels and a rack body front panel, where the upright member extends vertically from the rack base, a rack body tube attached to a top of the upright member where the rack body tube has a rack body tube hole, where the rack body tube has a width, and the width is approximately the same size as a distance between two fork members of a bicycle fork, such that one of the two fork members can be placed on one side of the rack body tube, and the other of the two fork members can be placed on the other side of the rack body tube, such that a bolt with a large end and a thread end can be slid through the rock body tube hole and the two fork members, and a nut can be attached to the threaded end of the bolt, and where the nut can be rotated about the thread end, thereby securing the fork members to the rack body tube,
where the cam strap portion comprises an attachment hook, a strap, and a cinch means, where the strap is threaded through the rack body front hole and the rack body rear hole, and where the strap is attached to the attachment hook, and where the attachment hook is secured over a bottom lip of the back door of a car, and where the cinch means is used to tighten the strap such that the bike rack is secured between the attachment hook and the at least one hook of the rack portion.

2. The bike rack of claim 1, where the rack body front panel additionally comprises a rack body front panel hole.

3. The bike rack of claim 2, where the hook has an angle, where the angle is measured against the rack base, and where the angle is less than 90 degrees.

4. The bike rack of claim 3, where the rack base has an upper side and a lower side, and where the lower side additionally comprises a protective layer of material that separates the lower side of the rack base from a roof of a car.

5. A bike rack, comprising a rack portion,
where the rack portion comprises a rack base with at least one hook which has a hook width, where the hook width is less than an average width between a car roof and a car back door, where there is a gap between the car roof and the car back door, and where the hook is secured in the gap,
where the rack base additionally comprises one or more curved edges, a rack body hole, through which a strap can be inserted,
and the rack portion additionally comprises an upright section, where the upright section additionally comprises an upright member, a rack body tube attached to a top of the upright member where the rack body tube has a rack body tube hole, where the rack body tube has a width, and the width is approximately the same size as a distance between two fork members of a bicycle fork, such that one of the two fork members can be placed on one side of the rack body tube, and the other of the two fork members can be placed on the other side of the rack body tube, such that a bolt with a large end and a thread end can be slid through the rock body tube hole and the two fork members, and a nut can be attached to the threaded end of the bolt, and where the nut can be rotated about the thread end, thereby securing the fork members to the rack body tube,

6. The bike rack of claim 5, additionally comprising a cam strap portion

7. The bike rack of claim 6, where the cam strap portion comprises an attachment hook, a strap, and a cinch means, where the rack body additionally comprises a front body front hole and a rack body rear hole, where the strap is threaded through the rack body front hole and the rack body rear hole, and where the strap is attached to the attachment hook, and where the attachment hook is secured over a bottom lip of the back door of a car, and where the cinch means is used to tighten the strap such that the bike rack is secured between the attachment hook and the at least one hook of the rack portion.

8. The bike rack of claim 7, where the number of hooks is two, and where the two hooks are separated from one another by a hook separation distance.

9. The bike rack of claim 8, where the hook separation distance is approximately three inches.

10. The bike rack of claim 5, where the upright member comprises two rack body side panels and a rack body front panel, where the upright member extends vertically from the rack base.

11. The bike rack of claim 5, where the rack body front panel additionally comprises a rack body front panel hole.

12. The bike rack of claim 11, where the hook has an angle, where the angle is measured against the rack base, and where the angle is less than 90 degrees.

13. The bike rack of claim 12, where the bike rack can be removed from the gap when the gap is in the gap open position, and where the bike rack is secured in the gap when the gap is in the gap closed position.

14. The bike rack of claim 12, where the rack base and the at least one hook are made from a same piece of a substance, and where the substance is bent during the manufacturing process to create at least one bend in the rack base and the at least one hook.

15. The bike rack of claim 14, where the substance is metal.

16. The bike rack of claim 14, where the substance is stainless steel.

17. A bike rack, comprising a rack portion,
where the rack portion comprises a rack base with at least one hook which has a hook width, where the hook width is less than an average width between a car roof and a car back door, where there is a gap between the car roof and the car back door, and where the at least one hook fits in the gap,
where the rack base additionally comprises a rack body front hole and a rack body rear hole, through which a strap can be inserted,
and the rack portion additionally comprises an upright section, where the upright section additionally comprises an upright member, a rack body tube attached to a top of the upright member where the rack body tube has a rack body tube hole,

18. The bike rack of claim 17, additionally comprising a cam strap portion,
where the cam strap portion comprises an attachment hook, a strap, and a cinch means, where the strap is threaded through the rack body front hole and the rack body rear hole, and where the strap is attached to the attachment hook, and where the attachment hook is secured over a bottom lip of the back door of a car, and where the cinch means is used to tighten the strap such that the bike rack is secured between the attachment hook and the at least one hook of the rack portion.

19. The bike rack of claim 18, where the rack body tube has a width, and the width is approximately the same size as a distance between two fork members of a bicycle fork, such that one of the two fork members can be placed on one side of the rack body tube, and the other of the two fork members can be placed on the other side of the rack body tube, such that a bolt with a large end and a thread end can be slid through the rock body tube hole and the two fork members, and a nut can be attached to the threaded end of the bolt, and where the nut can be rotated about the thread end, thereby securing the fork members to the rack body tube,

20. The bike rack of claim 19, where the upright member comprises two rack body side panels and a rack body front panel, where the upright member extends vertically from the rack base, where the hook has an angle, where the angle is measured against the rack base, and where the angle is less than 90 degrees.
